(19) United States
(12) Patent Application Publication
(10) Pub. No.: US 2003/0021518 A1
(43) Pub. Date: Jan. 30, 2003

(54) Optical transformer device

(75) Inventors: Anatoly Smirnov, Vancouver (CA); Sergey Rashkeev, Nashville, TN (US); Alexandre Zagoskin, Vancouver (CA); Jeremy P. Hilton, Vancouver (CA)

Correspondence Address: Gary S. Williams, Pennie & Edmonds LLP, 3300 Hillview Avenue, Palo Alto, CA, 94304, US

(73) Assignee: D-Wave Systems, Inc.

(21) Appl. No.: 10/159,326

(22) Filed: May 31, 2002

Related U.S. Application Data
(60) Provisional application No. 60/295,094, filed on Jun. 1, 2001.
(60) Provisional application No. 60/296,293, filed on Jun. 5, 2001.

(51) Int. Cl. G02B 6/26

(52) U.S. Cl. 385/15; 385/39; 385/43

(57) ABSTRACT

An optical transformer having an optical microsphere is disclosed. Resonant electromagnetic radiation can be trapped in the microsphere and can be manipulated with externally applied electric and magnetic fields to manipulate polarization components of the excited energy. In some embodiments, the resonant modes of the microsphere can be excited from optical fibers. Transitions between modes of the electromagnetic radiation trapped in the microsphere can be accomplished, providing mechanisms for manipulating excited energy in the microsphere. In the single photon regime, the disclosed optical transformer can be used as a quantum bit for application of quantum algorithms.

### RELATED APPLICATIONS

The present application is related to, and claims priority from, provisional application Ser. No. 60/296,293, filed Jun. 5, 2001, and provisional application Ser. No. 60/295,094, filed Jun. 1, 2001, both of which are herein incorporated by reference in their entirety.

### BACKGROUND

1. Field of the Invention

The invention relates to the field of optics, and especially to the use of optical resonators and optical transformers in quantum computing.

2. Description of Related Art

Research on what is now called quantum computing traces back to Richard Feynman. See, e.g., R. P. Feynman, Int. J. Theor. Phys., 21, 467 (1982). He noted that quantum systems are inherently difficult to simulate in classical (i.e., conventional, non-quantum) computers, but that this task could be accomplished by observing the evolution of another quantum system. In particular, solving a theory for the behavior of a quantum system commonly involves solving a differential equation related to the Hamiltonian of the quantum system. Observing the behavior of the quantum system provides information regarding the solutions to the differential equation.

Single qubit quantum computing generally involves initializing the states of N qubits (quantum bits), allowing these states to evolve, and reading out the qubits afterwards. A qubit is generally a system having two degenerate (i.e., of equal energy) quantum states, with a non-zero probability of being found in either state. Thus, N qubits can define an initial state that is a combination of 2^{N} classical states. During computation, the qubit system will undergo an evolution, governed by the interactions that the qubits have with external influences. This evolution defines a calculation—in effect 2^{N} simultaneous classical calculations, performed by the qubit system. Reading out the states of the qubits after evolution is complete thus reading the results of the calculations.

Several physical systems have been proposed for the qubits in a quantum computer. One system uses molecules having degenerate nuclear spin states, see N. Gershenfeld and I. Chuang, “Method and Apparatus for Quantum Information Processing”, U.S. Pat. No. 5,917,322. Nuclear magnetic resonance (NMR) techniques can read the spin states. These systems have successfully implemented a search algorithm, see, e.g., M. Mosca, R. H. Hansen, and J. A. Jones, “Implementation of a quantum search algorithm on a quantum computer,” Nature, 393:344, 1998, and a number ordering algorithm, see, e.g., Lieven M. K. Vandersypen, Matthias Steffen, Gregory Breyta, Costantino S. Yannoni, Richard Cleve and Isaac L. Chuang, “Experimental realization of order-finding with a quantum computer,” Los Alamos preprint quant-ph/0007017 (2000). The number ordering algorithm is related to the quantum Fourier transform, an essential element of both Shor's factoring algorithm and Grover's Search Algorithm for searching unsorted databases, see T. F. Havel, S. S. Somaroo, C.-H. Tseng, and D. G. Cory, “Principles and demonstrations of quantum information processing by NMR spectroscopy”, 2000. However, efforts to expand such systems to a commercially useful number of qubits face difficult challenges.

Of the current qubit proposals, only a few have the potential to achieve the required scalability to perform useful quantum computing. In order to solve problems on a useful commercial scale, a quantum computer would require a number of qubits on the order of 10²-10³. Thus far, only superconducting qubit proposals have shown the potential to realize this degree of scalability. However, superconducting implementations are restrictive in that they require low temperatures. Thus, there is a need for a simple and scalable high temperature qubit design.

### SUMMARY OF THE INVENTION

In accordance with embodiments of the present invention, an optical microsphere is presented as a quantum computing structure. A microsphere includes a material with a high optical path length, wherein the material has a spherical or ellipsoidal shape. In some embodiments, the material can be enclosed by a region with a different index of refraction. The surrounding region can have an index of refraction that is less than that of the enclosed region.

An optical coupler, or coupling mechanism, such as, for example, a coupling fiber or a prism coupler, couples electromagnetic radiation into and out of the microsphere. A coupling fiber includes a core region with a first refractive index surrounded by a cladding region with a second refractive index. In the region near the microsphere, the cladding region of the coupling fiber can be tapered. In some embodiments, the coupling fiber can be placed along the equatorial plane of the microsphere. Furthermore, in some embodiments a region of the microsphere cladding that is nearest to the coupling fiber can be removed. Further, a thin film can be deposited to cover the removed portion of microsphere cladding as an interface between the microsphere and the coupling fiber. The thin film can contain active atoms that can couple and decouple the coupling fiber from the microsphere in a controllable manner.

In another embodiment of the invention, a microsphere can be coupled to an optical prism, wherein laser energy reflecting through the prism can excite resonant modes in the microsphere.

In accordance with some embodiments of the invention, a polarization transformer that transforms the polarization of electromagnetic energy is disclosed. Resonant electromagnetic energy excited in a microsphere has fixed polarization components. A polarization transformer can manipulate the polarization state of the energy in the microsphere. In some embodiments, the polarization transformer can be a Faraday rotator. By acting on the microsphere, the polarization can be rotated in various ways. A polarization transformer can include at least two regimes for operating on different components of the polarization.

A microsphere can operate in a transverse magnetic (TM) or transverse electric (TE) mode. When the microsphere operates in the TM energy mode, the electric field component of the excited whispering gallery mode with high angular number (1>>1) is restricted to two polarization components, the E_{φ} or tangential component, and the Eᵣ or radial component. A method for transforming the polarization state of energy excited in a microsphere includes application of a uniform constant magnetic field, perpendicular to the equatorial plane. Another method for transforming the polarization state can include applying a phase shift on one of the polarization components. Applying a phase shift on the polarization state of the excited energy mode towards the tangential or E_{φ} component can include application of an alternating uniform magnetic field, perpendicular to the equatorial plane of the microsphere. Applying a phase shift on the polarization state of the excited energy mode towards the radial or Eᵣ component can include application of a radially directed uniform constant electric field.

A single photon can be treated as a quantum bit (qubit) wherein a microsphere, acting as a transformer, can be used to control and manipulate the polarization state of the photon. The basis states of the qubit can be the two polarization states E_{φ} and Eᵣ available to excited energy in a microsphere operating in the TM energy mode. The polarization transformer can perform operations on the qubit states. Quantum gate operations can include applying fields on the microsphere, which coincide with the operations used for transforming the polarization in the many photon regime. A method for causing the state of the qubit to oscillate between its basis states can include applying a uniform constant magnetic field, perpendicular to the equatorial plane of the qubit. A method for applying a phase shift on the tangential basis state E_{φ} can include application of an alternating magnetic field, perpendicular to the equatorial plane.

In some embodiments, a microsphere acting as an optical transformer can have a second energy mode as a first polarization state, and the TM energy mode as a second polarization state. A second energy mode can be the transverse electric (TE) energy mode of the microsphere, wherein a radial component of the electric field Eᵣ is absent (Eᵣ=0). In this regime, a polarization transformer can operate between the E_{θ}^{(TE)} and Eᵣ^{(TM)} polarization states, wherein the E_{θ}^{(TE)} or azimuthal state correlates with the TE energy mode, and the Eᵣ^{(TM)} or radial state correlates with the TM energy mode, each of the states having different frequencies. A method for tuning or oscillating between the TM and TE energy modes of the microsphere can include application of an alternating tangential magnetic field. This magnetic field can be produced by an alternating electric field, perpendicular to the equatorial plane. The frequency of the alternating field can be on the order of the frequency difference between the two energy modes. Due to the Faraday effect, application of such a tangential magnetic field will cause excited energy in the microsphere to oscillate between the two energy modes, consequently changing the polarization state.

Furthermore, a single photon can again be treated as a qubit, wherein the basis states of the qubit are the polarization components associated with the respective energy modes, E_{θ} of the TE mode, and Eᵣ of the TM mode available in a microsphere. A microsphere acting as a transformer can control and manipulate the state of a photon acting as a qubit. A method for controlling the rate of oscillation of the state of the qubit between the two modes can include application of an alternating electric field, perpendicular to the equatorial plane. The frequency of said field can be on the order of the frequency difference between the two energy modes acting as the basis states.

A microsphere in accordance with the invention provides a coherent medium for the interaction of a plurality of photons, wherein each of said photons can act as a qubit.

In some embodiments of the invention, an optical transformer system can include a microsphere, and at least one optical coupler, wherein an optical coupler can include a coupling fiber, or a prism. An optical coupler can be placed near the microsphere such that the influence of the electromagnetic field in the optical coupler extends into the microsphere, thereby stimulating an electromagnetic field inside the microsphere. Furthermore, an optical transformer system can include a magnitude field generator capable of applying magnetic fields to the microsphere. Furthermore, an optical transformer can include an electric field generator capable of applying electric fields to the microsphere. The electric field generator, in some embodiments, may electrically charge a stem of the microsphere as well as create an alternating electric field, perpendicular to the equatorial plane.

In some embodiments of the invention, a single qubit quantum computing system includes electromagnetic energy with an intensity on the order of a single photon, a microsphere, and at least one optical coupler. An optical coupler can be placed near the microsphere, such that the influence of an electromagnetic field in the coupler can extend into the microsphere, thereby stimulating an electromagnetic field inside the microsphere.

Some embodiments of a method for single qubit quantum computation includes a method for initializing the state of a photon, acting as a qubit, in a microsphere, and a method for reading out the state of a photon, acting as a qubit, in a microsphere. A method for single qubit quantum computation, wherein the qubit has a frequency resonant with the TM energy mode of a microsphere, can further include oscillating the energy polarization in a microsphere between the tangential and radial polarization basis states, or applying a phase shift on either the tangential polarization or the radial polarization state.

A method for single qubit quantum computation, wherein the qubit can have a frequency resonant with either of the TM and TE energy modes, can further include oscillating between the TM and TE energy modes, and can further include creating a phase shift between the two states.

A system for initializing excited energy in a microsphere includes a microsphere and an optical coupler, wherein a region of the optical coupler is placed near the microsphere. A method for initializing excited energy in a microsphere can include directing electromagnetic energy of a fixed polarization through an optical coupler, wherein the energy can have an intensity on the order of a single photon. Stimulating electromagnetic energy in the couplers, with a fixed polarization, will excite electromagnetic energy in the microsphere having the same polarization, momentum, and intensity. A mechanism for stimulating electromagnetic energy in a coupling mechanism can include an energy source capable of producing electromagnetic energy of a fixed intensity. Furthermore, a mechanism for stimulating electromagnetic energy in a coupler can be capable of energy intensities on the order of a single photon. Thus, the microsphere can be initialized with a tangential polarization, or a radial polarization, or a polarization that is some combination of the tangential and radial polarization. Furthermore, the coupler can be used to transfer the electromagnetic energy into the equatorial plane of the microsphere.

A system for reading out the state of excited energy in a microsphere includes a microsphere and a coupler, wherein a region of the coupler is placed near the microsphere. A method for reading out the state of excited energy in a microsphere includes measuring the electromagnetic energy that is excited in a coupler that is coupled to the microsphere being read. Measurement of the electromagnetic energy can include detecting the polarization, or angular momentum of the energy in the coupling mechanism.

These and other embodiments are discussed below with respect to the following figures.

### SHORT DESCRIPTION OF THE FIGURES

FIG. 1 shows a cross sectional view of the equatorial plane of an embodiment of a microsphere.

FIG. 2 shows a 3-dimensional view of an embodiment of a microsphere, illustrating the inner and outer regions, as well as the equatorial plane of the microsphere.

FIG. 3 shows a cross sectional view of an embodiment of a microsphere illustrating the E_{φ} or tangential polarization component and the Eᵣ or radial polarization component for the TM mode of the microsphere.

FIG. 4 shows a cross sectional view of an embodiment with a coupling fiber, wherein the coupling fiber illustrates tapered cladding in a region near the microsphere.

FIG. 5 shows a cross sectional view of an embodiment with a coupling, wherein the coupling fiber illustrates a pigtail in a region near the microsphere.

FIG. 6 shows a cross sectional view of an embodiment with a coupling fiber with a tapered cladding near the equatorial plane of the microsphere.

FIG. 7 shows a cross sectional view of an embodiment with a coupling fiber with a tapered cladding near the equatorial plane of a microsphere.

FIG. 8 shows a cross sectional view of an embodiment with N coupling fibers illustrating a pigtail near the equatorial plane of the microsphere.

FIG. 9 shows a cross sectional view of an embodiment of a microsphere with removal of a region of the surrounding cladding.

FIG. 10 shows a cross sectional view of a coupling fiber near the removed region of the microsphere shown in FIG. 9.

FIG. 11 shows a cross sectional view of an embodiment of a microsphere with a region of the surrounding cladding removed and with deposition of a thin film material in the removed region.

FIG. 12 shows a cross sectional view of an embodiment with a coupling fiber near a removed region of the microsphere shown in FIG. 11 that illustrates a thin film material as an interface between the microsphere and the coupling fiber.

FIG. 13 shows a cross sectional view of an embodiment of a microsphere with two regions where the cladding is removed, and corresponding tapered coupling fibers in close proximity to those regions respectively, and further illustrating a thin film interface between the coupling fibers and the microsphere.

FIG. 14 shows a cross sectional view of two coupling fibers in close proximity to the equatorial plane of a microsphere further including a third coupling fiber.

FIG. 15 illustrates an embodiment of a single qubit quantum computing system.

FIG. 16 illustrates an embodiment of a system where a microsphere can be mechanically manipulated to couple with an optical coupler.

In the figures, elements having the same designation have the same or similar functions.

### DETAILED DESCRIPTION

Technology for developing and controlling solid state devices that provide an extremely long optical path length for electromagnetic energy within a very small volume is of significant interest in the quantum optical communications field, as well as the quantum computing field. See for example, V. A. Braginski, “Unsolved problems in quantum optics (several short notes)”, Appl. Phys B, 60, 239 (1995), and D. Petrosyan, and G. Kurizkie, “Photon-photon correlations and entanglement in doped photonic crystals”, LANL quant-ph/0010106 (2000). A microsphere is one such solid state device that can be characterized by its resonant energy modes. Resonant electromagnetic energy in the microsphere can remain coherent for a maximum path length. For example, for a quality factor on the order of 10⁹, a photon lifetime can be greater than 1 μs, corresponding to an optical path of more than 300 m. The resonant energy mode in a microsphere can be characterized by factors such as the size and shape, the type of material that makes up the microsphere, and the surrounding material. A microsphere with a high quality factor Q, can have a long optical path in the microsphere and correspondingly an electromagnetic field can be maintained for a relatively long duration of time.

Some aspects of whispering gallery modes (WGM), referring to resonant electromagnetic radiation in a microsphere, has been investigated by V. B. Braginski, M. L. Gorodetsky, V. S. Ilchenko, “Quality-Factor and Nonlinear Properties of Optical Whispering-Gallery Modes”, Phys. Lett. A, 137, 393 (1989), and L. Collot, V. Lefevre-Sequin, M. Brune, J. M. Raiunol, S. Maroche, “Very High-Q Whispering-Gallery Mode Resonances Observed in Fused Silica Microspheres”, Europhys. Lett., 23, 327 (1993), and W. von Klitzing, R. Long, V. S. Ilchenko, J. Hare, and V. Lefevre-Seguin, “Tunable whispering gallery modes for spectroscopy and CQED experiments”, LANL preprint, quant-ph/0011102 (2000). Typically, the WGM is achieved for microspheres with a very high quality factor Q, which means that resonances will have minimal losses, and furthermore, that nonlinear effects can be achieved with low intensity energy. Electromagnetic fields with appropriate frequencies can stimulate WGMs in a microsphere. The resulting electromagnetic field inside the microsphere has a highly localized, low volume band along the equatorial plane of the microsphere. The WGM of a high-Q microsphere correlates with a high number of wavelengths along the equator.

Microspheres can be utilized as ultra compact narrow-band filters and spectrum analyzers, as well as for micro lasers and for optical locking for laser width narrowing. Braginsky, et al. focused on quantum non-demolition measurement, for a thermal bistability in the resonance wavelength of the microsphere. This use of the microsphere is extremely limited and unpractical for quantum computing systems. Most significantly, there would be no possibility for read out of the state of the system described by Braginsky, nor for application of quantum operations, two aspects which are important in quantum computing.

Microspheres have also been studied as coupling elements between nanocrystals, see for example, Todd S. Brun, and Hailin Wang, “Coupling nanocrystals to a high-Q microsphere: entanglement in quantum dots via photon exchange,” LANL quant-ph/9906025, (June 1999). In this paper, a fused silica sphere of diameter 20 μm and a quality factor (Q-factor) that exceeds 10⁹ is described as having a photon storage lifetime near a millisecond.

In accordance with an embodiment of the invention, a microsphere includes a material with a high optical path length, wherein the material can have a spherical or a mostly spherical shape that includes some distortion or ellipticity in the azimuthal axis (perpendicular to the equatorial plane). Furthermore, the material can be enclosed by a region with a different index of refraction. The surrounding region can have an index of refraction that is less than that of the enclosed region. The eccentricity of the microsphere plays a role in determining the frequencies of the resonant energy modes. For an ideally shaped sphere, the resonance energy modes with different azimuthal numbers |m|, are degenerate. The TM, with Hᵣ=0, and TE, with Eᵣ=0, modes have different resonant frequencies. As the shape of the microsphere becomes distorted in the azimuthal axis, a frequency difference between the resonant energy modes with different azimuthal numbers |m| can be found. In some embodiments of the invention, the microsphere can have a slightly distorted shape in the azimuthal axis such that the degeneracy in the modes with different azimuthal numbers |m| (where −1≦m≦1), is removed. Furthermore, the equatorial plane can be selected as the largest plane of the microsphere so that the optical path length is maximized.

In an embodiment of a microsphere, the cladding can be a material with a refraction index less than the refraction index of the core material. The cladding can be, for example, a vacuum, air, a gas, or a material. The cladding can be doped with a material that effects the electromagnetic fields inside the microsphere, or with a material that has a controllable effect on the fields in the microsphere as dependent upon external manipulation. In particular, the cladding can be doped along the equatorial plane. The cladding can be much thicker than the diameter of the microsphere core. The thickness of the doped region can be much less than the thickness of the cladding region.

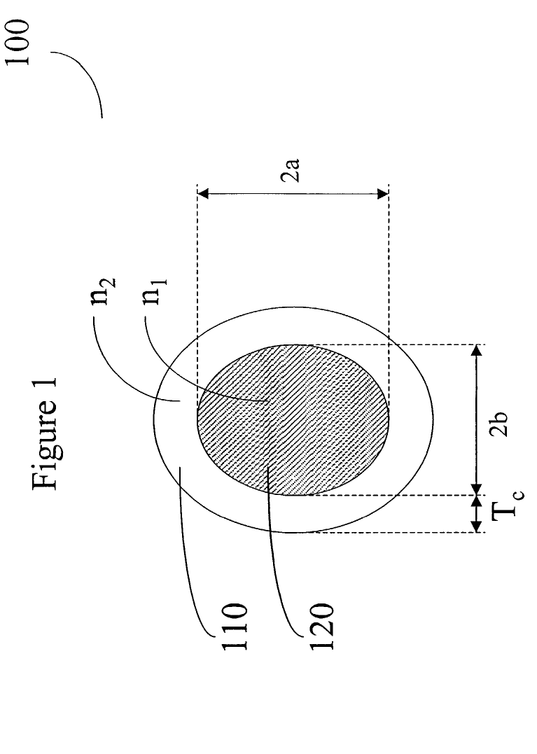

FIG. 1 illustrates a cross sectional view perpendicular to the equatorial plane of a microsphere 100. The length 2a and width 2b define, in part, the shape of the ellipsoid, and are exaggerated for illustrative purposes. The core material 120 of the microsphere has a first refractive index n₁, and the cladding of the micro sphere 110 has a second refractive index n₂. The refractive index n₂ can be less than the refractive index n₁. In an embodiment of a microsphere, the equatorial plane can remain spherical, while a distortion is imposed around the azimuthal axis. This distortion can introduce some ellipticity in the shape of the microsphere such that degeneracy in the magnetic quantum (azimuthal) number |m| is removed. Besides that, due to properties of total internal reflection, the resonant modes TE and TM, having different polarization characteristics, are distinguished by some non-zero frequency difference, Δf. The material of the core region 120 can be a material with a high optical path length. For example, the material of region 120 can be fused silica or polystyrene. The relative thickness of the cladding and core regions, 110 and 120 respectively, in the Figures are illustrative and are not to scale. The diameter of the core region 120 can be greater than the wavelength of its resonant energy. Furthermore, the diameter of the core region can be on the order of 5-100 μm for example. The material of the cladding region 110 can be a material with a refractive index less than the material in the core region 120. The thickness of the cladding region 110 can be much greater than the diameter of the core region 120. For example, the thickness of the cladding region can be much longer than the wavelength of the resonant energy of the core material. The thickness of the cladding can be on the order of 20-100 μm for example.

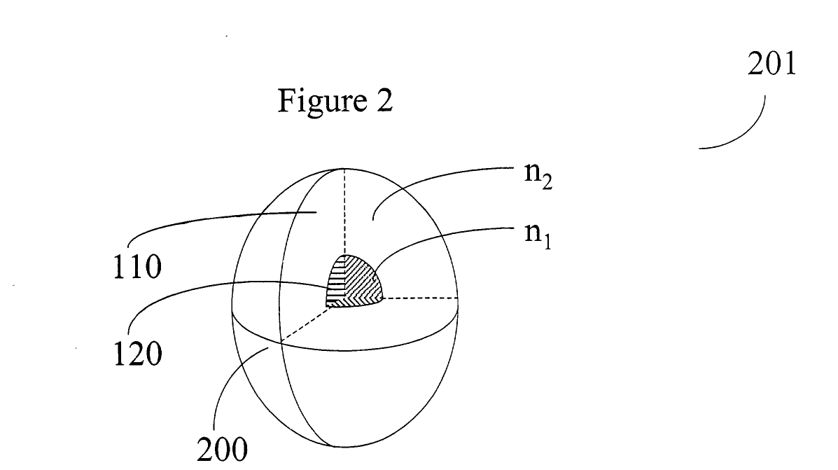

FIG. 2 illustrates a perspective view of a microsphere with a section removed. The equatorial plane 200 is indicated by the cross section labeled 200. The core region 120 with refractive index n₁ can be completely surrounded by the cladding region 110 with refractive index n₂. The thickness of the core region 120 can be less than the thickness of the cladding region 110.

In order to stimulate energy in a microsphere, it can be placed in an electromagnetic field that has a frequency tuned to a resonance mode of the microsphere. It is possible to trap an electromagnetic field in a microsphere by bringing the field in close proximity to the microsphere. For example, if an energy field with a frequency matching the TM resonance of a microsphere, and a polarization strictly in the radial component is brought in close proximity to the microsphere, then energy in the microsphere will be excited with the same polarization and frequency.

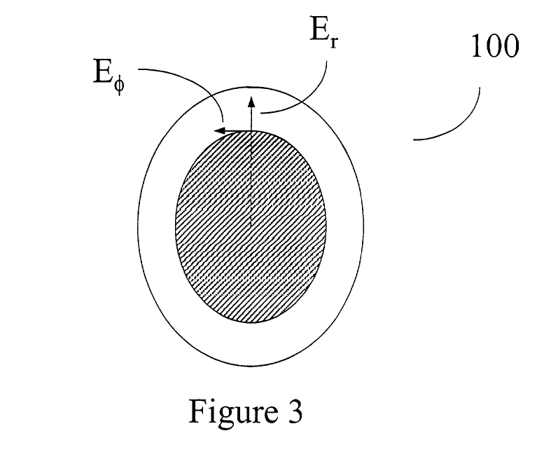

FIG. 3 illustrates the electric fields in microsphere 100. The radial polarization component Eᵣ and tangential polarization component E_{φ} are illustrated. FIG. 3 shows a cross section of microsphere 100 in equatorial plane 200.

One way of enabling excitation of the electromagnetic fields in a microsphere includes placing a coupling fiber in close proximity to the microsphere being initialized. In some embodiments of the invention, a coupling fiber includes a core region consisting of a first material with a first refractive index, and a cladding region consisting of a second material with a second refractive index. The cladding material of the coupling fiber can surround the core material. A coupling fiber can have a cladding region with a lower refractive index than the core region. The cladding can serve to insulate the core region of the fiber such that any electromagnetic energy that is stimulated in the core region of the fiber propagates with minimal losses due to total internal reflection at the boundary between the core material and the cladding material. The cladding region can have a thickness that is greater than the thickness of the core region. The cladding region can have a thickness that is much greater than the wavelength of the resonant electromagnetic energy of the TM or TE mode in a microsphere. Furthermore, the cladding region can have a thickness of 100 μm for example. The core region of the coupling fiber can have a diameter on the order of the wavelength of the resonant energy of the TM or TE mode of a microsphere. The diameter of the core region can be on the order of 1-5 μm for example.

The coupling fiber can have a region of the cladding that is tapered to expose the core region of the fiber. In a region where the cladding is removed from the fiber, total internal reflection of the electromagnetic energy in the core region of the fiber will decrease, resulting in the cladding suppressed region having a more broadly distributed electromagnetic field.

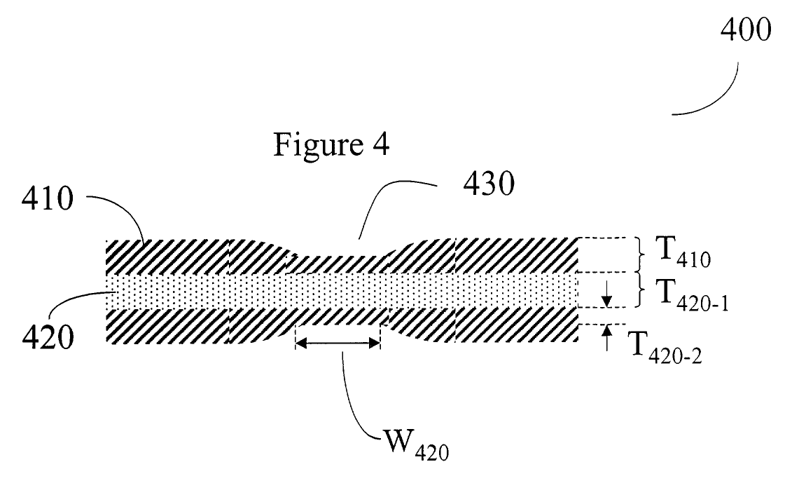

FIG. 4 illustrates a cross-sectional view of an embodiment of a coupling fiber 400 having a tapered region 430 of cladding material 410. In tapered region 430, the thickness of the cladding can be decreased from T₄₂₀₋₁ to a thickness T₄₂₀₋₂. The thickness T₄₂₀₋₂ can be 0, where core 420 of coupling fiber 400 is completely exposed within tapered region 430. In the cladding tapered region 430, cladding 410 can have a thickness T₄₂₀₋₂ less than the wavelength of the resonant TM of TE mode energy for a microsphere. Region 430 of tapered cladding can extend over a width of W₄₂₀. The width W₄₂₀ can be on the order of the wavelength of resonant TM or TE mode energy in a microsphere. In some embodiments, tapered region 430 can have the cladding tapered asymmetrically.

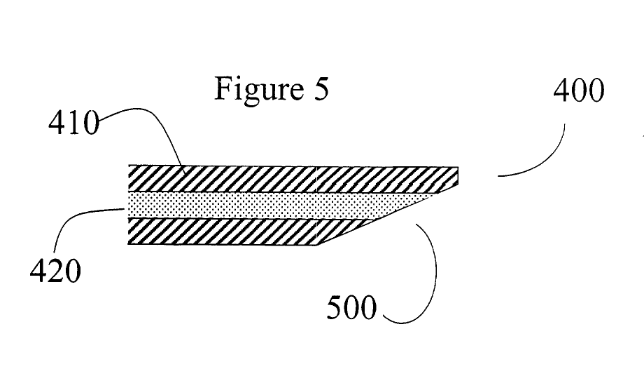

FIG. 5 shows another embodiment of coupling fiber 400 with a tapered end 501, which is commonly referred to as a pigtail. The embodiments of coupling fiber 400 shown in both FIGS. 4 and 5 can couple energy into microsphere 100.

In some embodiments of the invention, the electromagnetic fields between the fiber and the microsphere are coupled by placing a coupling fiber with a region wherein electromagnetic energy has an increased field of influence near a microsphere. When an electromagnetic energy with a frequency matching a resonant mode of the microsphere is stimulated in the coupling fiber, that resonant mode will be excited in the microsphere, wherein the energy in the coupling fiber will be trapped. In some embodiments of the invention, energy with a frequency and wavevector matching the resonant TM or TE mode in a microsphere is stimulated in a coupling fiber that includes a region of tapered cladding that further passes near a microsphere. The energy in the coupling fiber will further excite the TM or TE mode of the microsphere. The energy in the coupling fiber can have a polarization in the E_{φ}, or Eᵣ, or some combination of the E_{φ} and Eᵣ components for the TM mode, and E_{θ} for the TE mode, which will in turn excite energy in the microsphere with the same polarization.

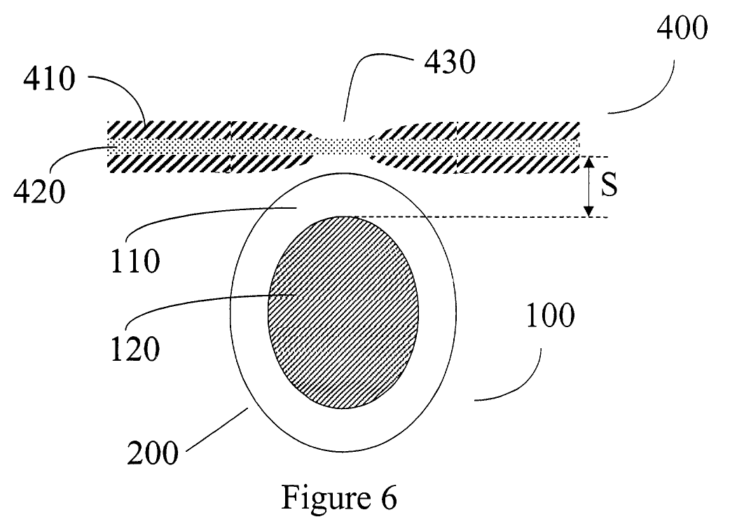

FIG. 6 illustrates a cross sectional view of a coupling fiber 400 as shown in FIG. 4 with a tapered region 430 in close proximity to equatorial plane 200 of a microsphere 100. The tapered region 430 of the coupling fiber 400 is a distance S from the core region of the microsphere. If an electromagnetic field with a frequency and wavevector matching a resonance mode of microsphere 100 is sent along coupling fiber 400, then in taper region 430 where the cladding of the coupling fiber tapers the field will overlap the microsphere, thus exciting energy in the core of microsphere 100 with the same frequency, polarization, and momentum. The electromagnetic energy in coupling fiber 400 can be of a frequency and wavevector matching the TM mode of microsphere 100, with a polarization in the E_{φ}, or Eᵣ, or with a polarization in a superposition of both components for the TM mode, and E_{θ} for the TE mode. Coupling fiber 400 can be located along the equatorial plane 200 of microsphere 100. Coupling fiber 400 can, for example, be located parallel with the 2a axis of the equatorial plane. Some embodiments of the invention can include a plurality of coupling fibers directed in different directions adjacent microsphere 100.

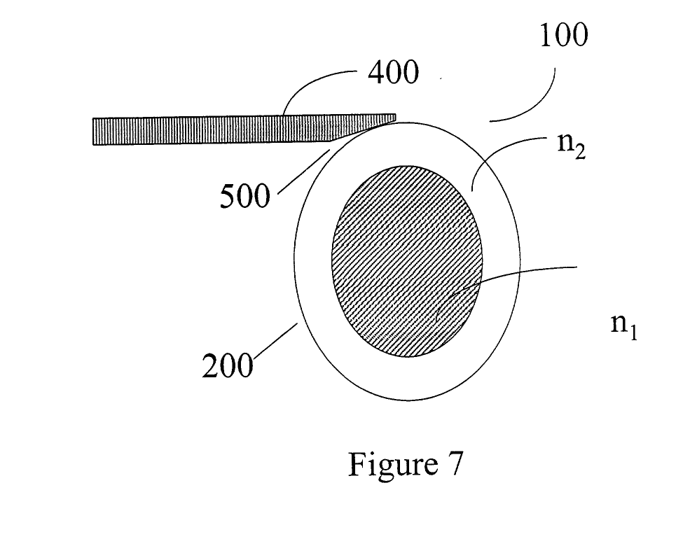

FIG. 7 shows a cross sectional view of an embodiment of coupling fiber 400 as illustrated in FIG. 5 with a pigtail 500 placed in proximity with microsphere 100. In some embodiments, pigtail 500 can be placed along equatorial plane 200 of microsphere 100.

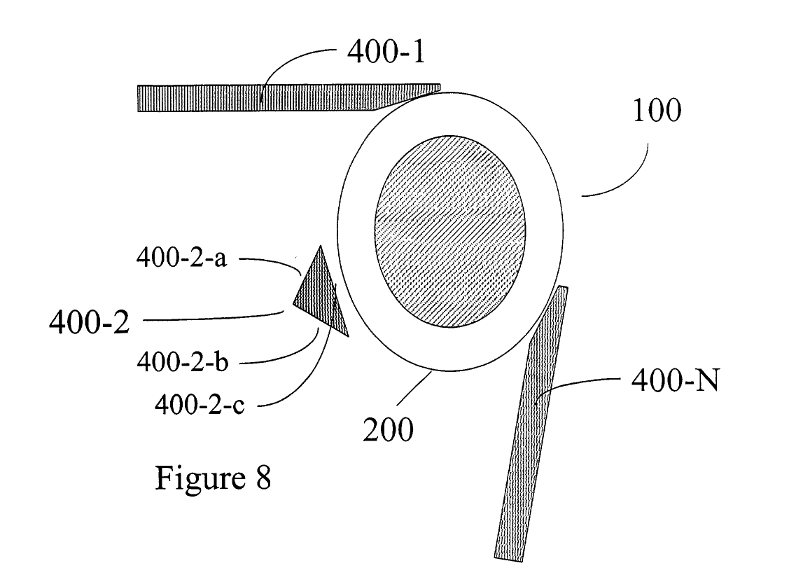

FIG. 8 shows a cross sectional view of a plurality of optical couplers 400-1 through 400-N placed near the equatorial plane of a microsphere 100. Each of the couplers 400-1 through 400-N can be controlled separately to individually couple electromagnetic radiation into microsphere 100. In particular, FIG. 8 illustrates coupler 400-2 as a triangular prism having sides 400-2-a, 400-2-b, and 400-2-c. In operation, electromagnetic energy can be incident upon one of 400-2-a or 400-2-b and will couple to microsphere device 100 through side 400-2-c.

A method for initializing a resonant mode of a microsphere includes placing a microsphere in an electromagnetic field with a frequency and wave vector matching a resonant mode of the microsphere. A system for initializing a resonant mode of a microsphere includes a coupling fiber, and a microsphere, wherein the coupling fiber is placed near the microsphere, as is illustrated in FIGS. 6, 7 and 8. Thus, a method for initializing a resonant mode of microsphere 100 includes stimulating an electromagnetic energy in coupling fiber 400 with a frequency that matches a resonant mode of microsphere 100. In some embodiments of the invention, an energy with a frequency matching the TM mode of the microsphere and a polarization in either the E_{φ}, Eᵣ, or a combination of both components for the TM mode, and E_{θ} for the TE mode, is stimulated in coupling fiber 400. The components E_{φ}, Eᵣ are illustrated in FIG. 3.

Furthermore, as per the above, whispering gallery modes in microsphere 100 can be excited through a high index prism by frustrated total internal reflection. Methods for coupling energy into a microsphere are well known. See, e.g., W. von Klitzing, R. Long, V. S. Ilchenko, J. Hare, V. Lefevre-Segui, “Tunable whispering gallery modes for spectroscopy and QCED experiments”, LANL preprint, quant-ph/0011102 (November 2000), herein incorporated by reference in its entirety.

The path length of energy in microsphere 100 is optimized when there is no coupling to the outside environment. When an optical coupler is placed in close proximity to the microsphere, the coupling between the optical coupler and microsphere 100 reduces the path length or lifetime of energy in microsphere 100. One such coupling mechanism is coupling due to losses in coupling fiber 400. Thus, it is useful to provide a method for coupling and decoupling a fiber or prism to the microsphere in a controllable manner.

The extent of influence of the electromagnetic energy in coupling fiber 400 or microsphere 100 exponentially decays from the source. In some embodiments of the invention, cladding 110 (FIG. 1) can include two regimes. In a first regime, the material of cladding 110 blocks electromagnetic fields, whereas in a second regime, the material allows the electromagnetic fields to pass. The material can include active atoms such as Nd (Neodymium) or Er (Erbium) for example. The cladding region 110 of microsphere 100 can be doped with the active atoms. Furthermore, the cladding region can be doped in specific areas, such as, for example, in equatorial plane 200 of microsphere 100. Electromagnetic radiation then can be coupled into microsphere 100 through the doped plane (e.g., equatorial plane 200) but not in other planes.

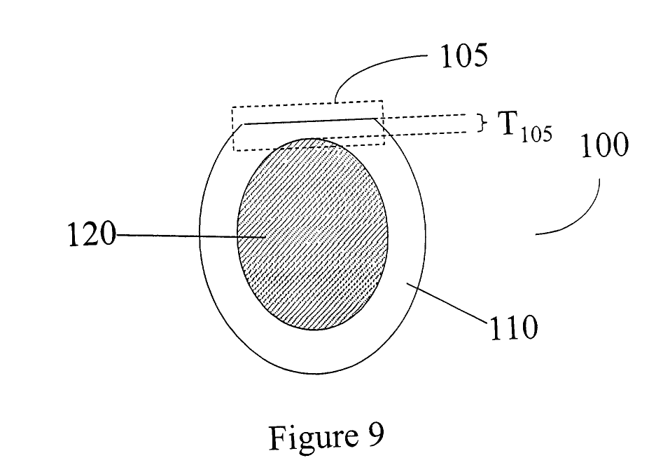

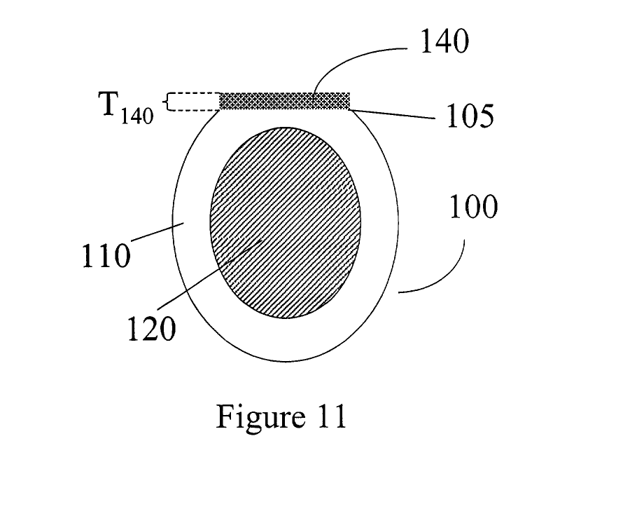

In some embodiments of the invention, a portion of cladding 110 of microsphere 100 can be removed to form a removed region 105 (FIG. 9). In some embodiments, a film of material 140 (FIG. 11) can be deposited in removed region 105. Deposited film 140 can have a thickness T₁₄₀ less than the order of the wavelength of the resonant energy of the TM mode of microsphere 100.

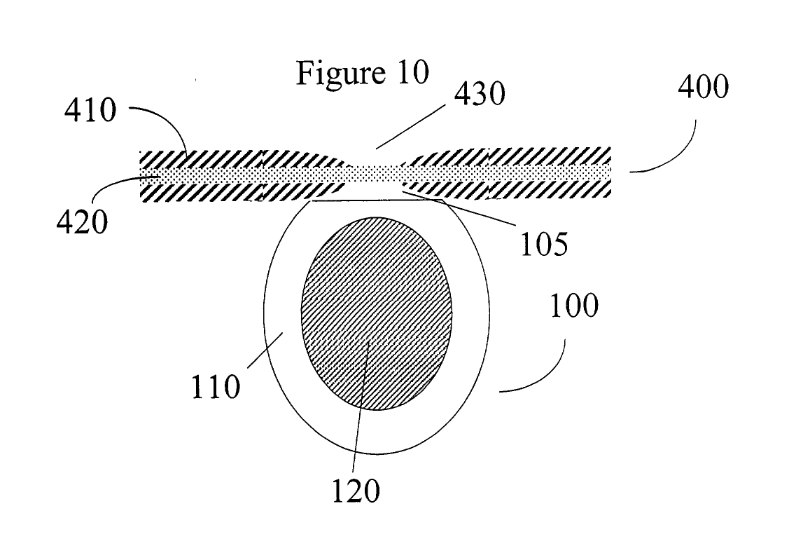

FIG. 9 illustrates a microsphere 100, with a portion 105 of the cladding region removed, to leave a remaining cladding region of new thickness T₁₀₅. FIG. 10 illustrates a cross sectional view of a coupling fiber 400 near the region of removed cladding, portion 105. In particular, tapered region 430 of tapered cladding on coupling fiber 400 can be placed near removed portion 105 of cladding 110.

FIG. 11 illustrates deposition of a film of a material to form deposited layer 140, of thickness T₁₄₀, on removed portion 105 of cladding 110 on microsphere 100. Deposited layer 140 can be of a material that can have more than one regime. A first regime can prevent coupling between coupling fiber 400 and microsphere 100, and a second regime can allow the exchange of electromagnetic energy between microsphere 100 and coupling fiber 400. Deposited layer 140 can include active atoms which can be externally activated. The activation frequency of the active atoms, as discussed above, in deposited layer 140 can be of a different order than the resonance of microsphere 100. In some cases, the regimes of deposited layer 140 can be controlled by application of energy fields, or by application of charge directly through the layer. Application of a charge through deposited layer 140 can include attaching electrodes across the material.

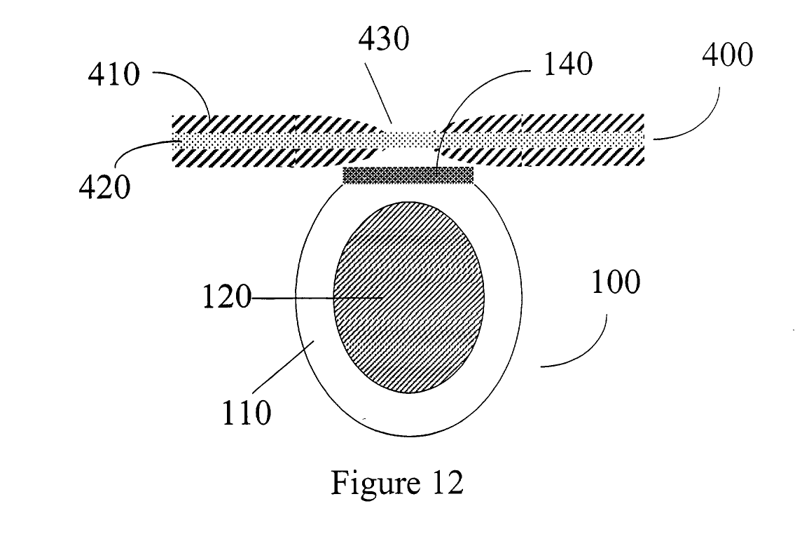

FIG. 12 illustrates a coupling fiber 400 in close proximity to deposited layer 140 deposited in removed portion 105 of cladding 110 of microsphere 100. Electromagnetic energy can be coupled through deposited layer 140 into core 120 of microsphere 100. As discussed above, in some embodiments, deposited layer 140 can be controlled to couple or not couple radiation between coupling fiber 400 and core 120 of microsphere 100.

Some embodiments of the invention can include a plurality of coupling mechanisms, including different embodiments of coupling fiber 400. Furthermore, microsphere 100 can include a plurality of regions where portions of cladding 110 are removed. Further, any of these portions can include deposited layers 140 of material in the regions of removed cladding 105. In some embodiments of the invention, a coupling mechanism can be coupled to each of the regions of the microsphere where cladding 110 has been removed.

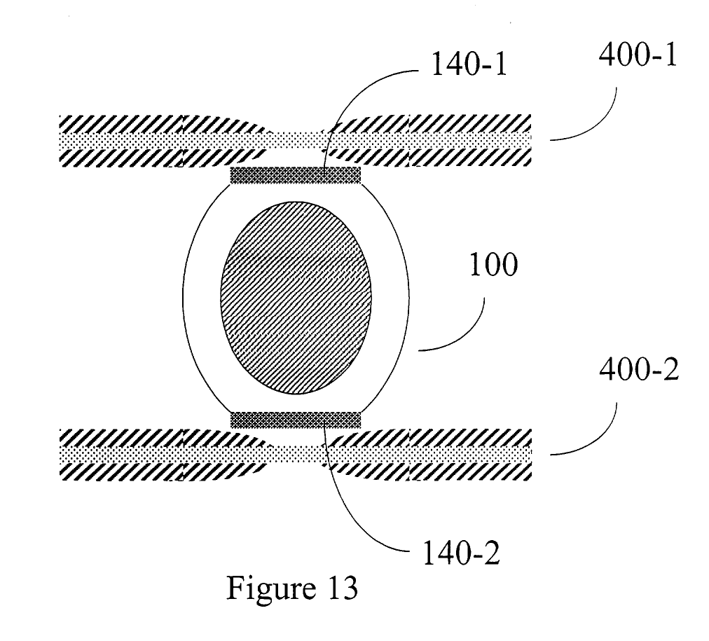

FIG. 13 illustrates an embodiment of microsphere 100 with two regions of reduced cladding with deposited layers 140-1 and 140-2. Coupling fibers 400-1 and 400-2 are placed near layers 140-1 and 140-2 respectively. The concept can easily be generalized to a plurality of coupling fibers or coupling mechanisms such as prisms for example.

Some embodiments of the invention include a further coupling mechanism, called a control mechanism, wherein the control mechanism is in close proximity to microsphere 100. The control mechanism can be, for example, a fiber or a prism. The control mechanism could be used to direct the microsphere into at least two regimes, wherein a first of the at least two regimes decouples the microsphere from the remaining coupling mechanisms, and a second of the at least two regimes couples the microsphere to the remaining fibers. Manipulating the control fiber can include shifting its resonant frequency due to the Kerr effect, by application of external fields. A control mechanism can be coupled to a microsphere by any of the above mentioned methods, and can further have a frequency spectrum out of the frequency range of the TM or TE energy modes in the microsphere. The control mechanism can be coupled to a plurality of microspheres.

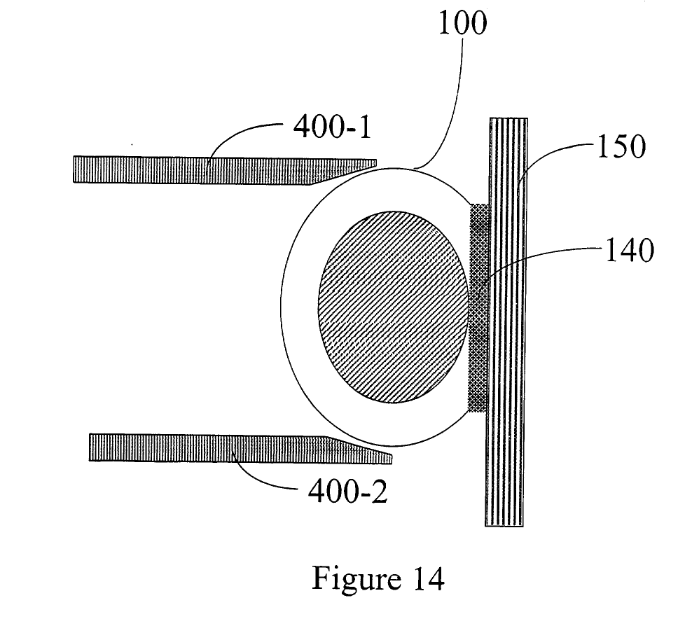

FIG. 14 illustrates the inclusion of a control fiber 150 to microsphere 100. In the embodiment shown in FIG. 14, coupling fibers 400-1 and 400-2 couple radiation into microsphere 100. The control fiber 150 is near the microsphere 100, and can include a deposited layer 140 of material in addition to the microsphere cladding 110 between control fiber 150 and microsphere 100.

Shifting the proximity of a coupling mechanism to or from microsphere 100 can control the extent of coupling between microsphere 100 and the coupling mechanism. In some embodiments of the invention, the spatial position of a microsphere 100 is controlled and can be shifted between at least two regimes, wherein a first of the at least two regimes leaves microsphere 100 in a position where microsphere 100 and the coupling mechanism are coupled, and a second of the at least two regimes leaves microsphere 100 in a position where microsphere 100 and the coupling mechanism are decoupled. In some embodiments of the invention, a mechanism for shifting the microsphere between two of the at least two regimes includes using at least one piezoelectric device or ultrasound generator.

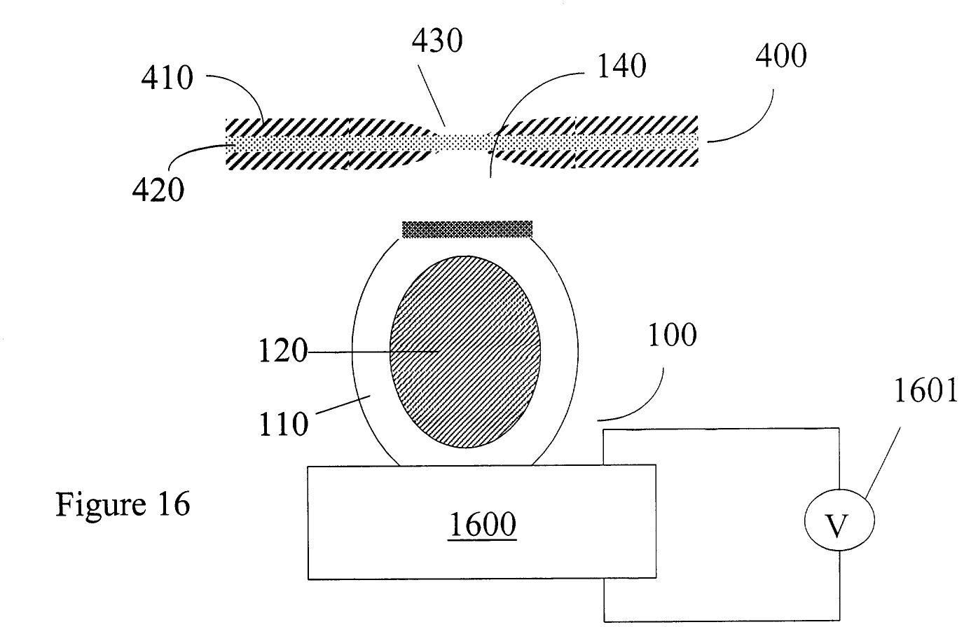

FIG. 16 shows an embodiment of the invention where microsphere 100 can be mechanically coupled to coupling fiber 400. Microsphere 100 is mechanically moved by piezoelectric crystal 1600 (which, for example, can be quartz). Piezoelectric crystal 1600 can be controlled by voltage source 1601 such that microsphere 100 is moved to a first position close to coupling fiber 400 to couple radiation between coupling fiber 400 and microsphere 100 and a second position sufficiently removed from coupling fiber 400 such that there is substantially no coupling between coupling fiber 400 and microsphere 100. Although FIG. 16 shows mechanical motion of microsphere 100 towards and away from coupling fiber 400, some embodiments may move microsphere 100 along coupling fiber 400 so that the cladding layer 410 of coupling fiber 400 prevents coupling between coupling fiber 400 and microsphere 100. Additional variations include moving coupling fiber 400 relative to microsphere 100.

Two types of energy modes can exist in a spherical resonator, the TE energy mode, wherein the radial electric field component of excited energy in the microsphere is zero, and the TM energy mode, wherein the radial magnetic field component of the excited energy microsphere is zero. See, for example S. Schiller, et al., Optics Lett., 16, 1138 (1991), herein incorporated by reference in its entirety. The electric field distribution inside microsphere 100 for traveling-wave modes is characterized by numbers p, 1, and m, where a radial number p gives the number of maxima in the radial dependence of the mode, an angular mode number 1, roughly described the number of wavelengths in a pass around the microsphere, and an azimuthal mode number m, which can be the integer values in the range −1≦m≦1. The mode numbers 1 and m describe the angular momentum of the mode. The residual symmetry of the microsphere (eccentricity for example) serve to break the symmetry of the sphere, and lift the degeneracy of the different |m| modes. To minimize the mode valence while maintaining the very high-Q, it is desirable to excite modes with m=±1. Such modes have only a few lobes and are closely confined to the equatorial region of microsphere 100.

The TE energy mode of microsphere 100 has associated excited energy that is restricted to a single polarization component of the electric field, that being the E_{θ} or azimuthal component perpendicular to the equatorial plane. Whereas the TM mode of microsphere 100 has associated excited energy that is restricted to 2 polarization components in the electric field, those being the E_{φ}, or tangential component, and the Eᵣ or radial component that belongs to the equatorial plane (see FIG. 3).

In accordance with the present invention, a device for transforming the polarization of electromagnetic energy is disclosed. Some embodiments of a method for transforming the polarization of resonant electromagnetic energy in microsphere 100 can include exciting resonant electromagnetic energy in a mode of microsphere 100, wherein the energy has a fixed polarization, a mechanism for transforming the polarization of the energy can be applied while in microsphere 100, and a method for transferring the energy out of the microsphere 100. A mechanism for transforming the polarization of the energy in the microsphere can include application of fields on microsphere 100, such that the polarization state of the energy is changed in some way.

In some embodiments of the invention, a microsphere 100 can operate in the TM energy mode. In the TM mode, a mechanism for transforming the polarization state of excited energy can include a mechanism for oscillating the polarization of the electromagnetic field. Such a mechanism can include application of a uniform constant magnetic field, perpendicular to equatorial plane 200. The effect of a uniform constant magnetic field, applied in said manner, is to cause the polarization state of the electric field component to oscillate between the E_{φ}, and Eᵣ components due to the Faraday effect. A uniform constant magnetic field can be applied to a microsphere, by external source of magnetic field, in a direction perpendicular to the equatorial plane of the microsphere.

In the TM mode, a method for transforming the polarization state of energy can include use of a mechanism for application of a phase shift on one of the allowed polarization states. A mechanism for application of a phase shift on the tangential or E_{φ} component includes application of an alternating uniform magnetic field, perpendicular to the equatorial plane of the microsphere. This alternating magnetic field will generate a tangential electric field that will change a reflection index for the electrical component of the excited energy in the microsphere. The magnetic field can have a wavelength longer than the size of the microsphere. An alternating uniform magnetic field can be applied to a microsphere by propagating electromagnetic energy with a wavelength longer than the diameter of the microsphere in a direction perpendicular to the equatorial plane of the microsphere. In some embodiments of the invention, the electromagnetic energy can be microwaves produced by a microwave generator.

A mechanism for application of a phase shift on the radial or Eᵣ component can include application of a radially-directed constant electric field.

The excited electromagnetic energy in the microsphere is contained in the core region by processes of total internal reflection (TIR). These processes give rise to a frequency shift between the TM and TE energy modes. In some embodiments of the invention, an optical transformer can include a microsphere operating in either the TM or the TE energy modes. By tuning the microsphere between the resonant TM and TE energy modes, excited energy can be shifted between two polarization components. For example, the excited energy can take a polarization, E_{θ}^{(TE)} with the associated TE mode frequency, and a polarization Eᵣ^{(TM)} with the associated TM mode frequency. A mechanism for tuning or oscillating the microsphere between the two energy modes can include a mechanism for applying an alternating electric field, perpendicular to the equatorial plane of the microsphere. This field produces a tangential alternating magnetic field. The frequency of the alternating field can be on the order of the frequency difference between the two energy modes. In an embodiment of the invention, the frequency difference between the modes can be 100-600 GHz, and a tuning field frequency can have the same frequency. A method for shifting the polarization of excited energy in the microsphere can include applying an alternating electric field, perpendicular to the equatorial plane for a fixed duration of time. The duration can be chosen to represent an oscillation from one polarization state to another. A phase shift between the two modes E_{θ}^{(TE)} and Eᵣ^{(TM)} will intrinsically oscillate in time with a frequency equal to the difference between resonant frequencies of the TM and TE modes. A phase shift between E_{θ}^{(TE)} and Eᵣ^{(TM)} can be obtained after a period of time.

Some embodiments of the invention can act as a qubit transformer for application of quantum computing algorithms, wherein a microsphere can operate in the TM energy mode and in the single photon energy intensity regime, or alternately, in the TM and TE energy mode, as well as in the single photon energy intensity regime.

A photon can store quantum information, wherein the basis states of a photon can be represented by polarization components such as E_{φ} and Eᵣ, and can thus act as a qubit. Alternately, a photon can act as a qubit, wherein the basis states of the qubit are represented by two different energies, the frequencies of which are resonant with the TE and TM energy modes of a microsphere. A photon qubit, can be manipulated, controlled, and evolved when it is placed in an optical transformer in accordance with an embodiment of the invention.

In an embodiment of the invention, a single qubit quantum computing system includes a qubit, a mechanism for initializing a qubit, and a mechanism for reading the state of a qubit. A qubit can be a photon restricted to two polarization states. A microsphere can be used as a mechanism for transforming and manipulating the state of a photon acting as a qubit. A mechanism for initializing or reading the state of the qubit from a microsphere can include at least one coupling fiber or prism. A coupling fiber can be placed near the microsphere, such that the influence of the electromagnetic energy in the fiber excites energy in the microsphere, thereby initializing the state of the microsphere.

A microsphere excited in the TM energy mode can be treated as a qubit transformer, or mechanism for applying quantum gates. A photon, with basis states represented by a polarization entirely in the E_{φ} direction, or entirely in the Eᵣ direction, and a frequency resonant with the TM mode of a microsphere, can act as a qubit and can be controlled by an embodiment of the invention. Quantum evolution can include application of quantum gates that cause the electromagnetic energy to oscillate between either polarization or basis states, or to apply a phase shift operation to a particular polarization or basis state. A mechanism for tuning the rate of oscillation of the state of the qubit can include a mechanism for allowing the polarization to freely rotate between the two possible polarizations, with a frequency of oscillation proportional to the external magnetic field. Furthermore, a mechanism for quantum evolution of the qubit can further include, application of a phase shift on one of the states of the qubit. As discussed in the general case for TM mode operation, transformation of the polarization states of the excited energy in the microsphere can be achieved through the application of fields. Tuning the rate by which the microsphere polarization state oscillates can be controlled by application of a uniform constant magnetic field, perpendicular to the equatorial plane. Application of a phase shift on the tangential polarization component can include application of an alternating magnetic field, perpendicular to the equatorial plane.

A photon can act as a qubit, wherein the basis states of the qubit are the TM and TE energy modes. Such a photon can be excited in an embodiment of the invention, wherein the state of the qubit can be controlled, manipulated, and evolved. An embodiment of a single qubit quantum computing system, wherein the qubit is a photon with the TM and TE energy modes as basis states, can include a mechanism for inducing a controllable oscillation rate between the two resonant modes. A mechanism for controlling oscillations between the energy modes can include application of an alternating electric field, perpendicular to the equatorial plane of the microsphere. This field creates a tangential alternating magnetic field. The alternating field can have a frequency that matches the frequency difference Δf between the two energy modes TE and TM. In an embodiment of the invention, Δf can be on the order of 10²-10³ GHz, for example, Δf can be 100-600 GHz.

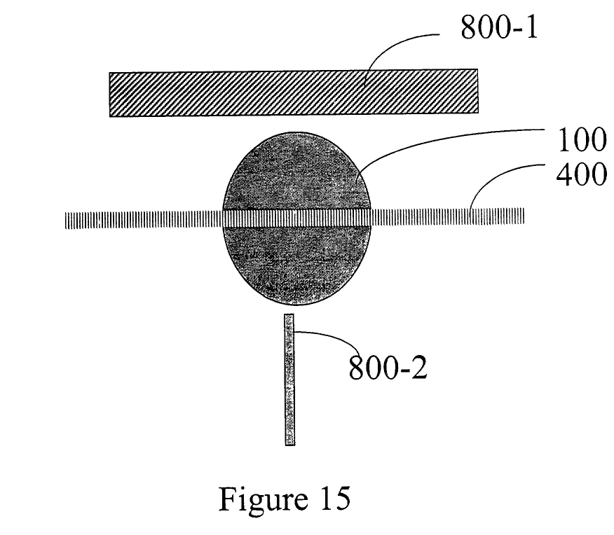

FIG. 15 illustrates an embodiment of an optical transformer system that includes a microsphere 100, a microwave generator 800-1, a chargeable stem 800-2, and a coupling mechanism, illustrated as a coupling fiber 400. A method for initializing the microsphere 100 can include stimulating an electromagnetic energy in the coupling fiber 400. In an embodiment of an initialization, an electromagnetic field is applied perpendicular to the equatorial plane of the microsphere before an initializing energy pulse is stimulated in the coupling fiber 400. The optical transformer system can be treated as a quantum computing system, wherein a photon can be used as a qubit, with basis states either in the TM energy mode radial and tangential polarizations, or in the TM and TE energies themselves. Since these basis states correlate with resonant frequencies if the microsphere, an embodiment of the invention can be a qubit transformer, allowing the control, manipulation, and evolution of the state of the qubit. The electromagnetic field generator 800-1 can apply a field for tuning the microsphere 100 into a coupling regime with the coupling fiber. A method for transforming the polarization of the electromagnetic energy in the microsphere 100 includes application of a uniform field perpendicular to the equatorial plane of the microsphere. A method for applying a phase shift on a tangential polarization component of the state of the microsphere can include applying a uniform alternating electromagnetic field, perpendicular to the equatorial plane of the microsphere. A microwave generator 800-1 can apply alternating microwave pulses. The alternating field can have a wavelength greater than the diameter of the microsphere. A method for applying a phase shift on a radial polarization component of the state of the microsphere can include applying an electric field that is symmetric about the azimuthal axis of the microsphere, perpendicular to the equatorial plane of the microsphere. The electric field should have components with respect to the radial direction of the microsphere. A charging stem 800-2 can be charged to create said field. A method for oscillating the polarization state of the microsphere includes applying a uniform magnetic field perpendicular to the equatorial plane of the microsphere. The magnitude of the magnetic field can determine the frequency at which the state of the microsphere oscillates between the two polarization states.

In an embodiment of the invention, the microwave generator 800-1 can be used to apply alternating microwave pulses with a frequency equal to the frequency difference between the TM and TE energy modes of the microsphere. Thus, a microsphere can be set to oscillate between the polarization components associated with the TM and TE energy modes respectively. Phase shifting between the TE and TM modes can be realized by using an intrinsic beating between the E_{θ}^{(TE)} and Eᵣ^{(TM)} polarizations.

The embodiments of the present invention described above are examples only and are not intended to be limiting. One skilled in the art will recognize variations which are intended to fall within the spirit and scope of the present disclosure. As such, the invention is limited only by the following claims.

We claim:

1. A structure, comprising:
a microsphere; and
at least one optical coupler proximate to the microsphere,
wherein electromagnetic energy can be coupled between the microsphere and the at least one optical coupler, and
a field generator proximate the microsphere, wherein electromagnetic fields can be applied to the structure.

2. The structure of claim 1, further including
a charging stem proximate the microsphere.

3. The structure of claim 1, wherein the at least one optical coupler includes a coupling fiber having a tapered region where a cladding of the fiber is thinned, the tapered region being positioned proximate the microsphere.

4. The structure of claim 1, wherein the at least one optical coupler includes a coupling fiber with a tapered end, the tapered end being positioned proximate the microsphere.

5. The structure of claim 1, wherein the at least one optical coupler includes a prism.

6. The structure of claim 1, wherein the microsphere includes a core and a cladding layer.

7. The structure of claim 6, wherein the cladding layer of the microsphere includes a thinned region, one of the at least one coupling fibers being proximate to the thinned region.

8. The structure of claim 7, wherein a material layer is deposited in the thinned region.

9. The structure of claim 7, wherein the material layer can be manipulated to controllably reduce coupling between the coupling fiber proximate the thinned region and the core of the microsphere.

10. The structure of claim 1, further including a mechanical manipulator that can control the separation one of the at least one coupling fibers and the microsphere.

11. The structure of claim 1, wherein the field generator produces a uniform magnetic field across the microsphere in an equatorial plane of the microsphere, wherein a polarization state of energy in the microsphere is transformed.

12. The structure of claim 11, wherein the uniform magnetic field is a microwave field.

13. The structure of claim 12, wherein the field generator produces a constant magnetic field across the microsphere in an equatorial plane of the microsphere.

14. The structure of claim 1, further including a photon with two states is trapped on the microsphere.

15. The structure of claim 14, further including a field generator to provide electromagnetic fields in the equatorial plane, the electromagnetic fields controlling transitions of the photon between the two states.

16. The structure of claim 14, wherein the two states are two polarization states.

17. The structure of claim 14, wherein the two states are two energy states.

18. The structure of claim 14, further including at least one other photon trapped on the microsphere.

19. A method of performing quantum calculations on a microsphere, comprising:
coupling a photon at a resonance of the microsphere, the microsphere having energetically degenerate resonances which form the basis of the quantum calculation; and
inducing controllable oscillation rates between the degenerate resonances.

20. The method of claim 19, wherein coupling a photon includes positioning a coupling fiber in close proximity to the microsphere and applying photons of appropriate polarization and wavelength to excite the resonance of the microsphere.

21. The method of claim 20, wherein positioning the coupling fiber includes positioning a tapered region of the coupling fiber in close proximity to the microsphere.

22. The method of claim 20, wherein positioning the coupling fiber includes positioning a tapered end of the coupling fiber in close proximity to the microsphere.

23. The method of claim 20, wherein positioning the coupling fiber includes positioning the coupling fiber proximate to a thinned portion of a cladding layer of the microsphere.

24. The method of claim 23, further including manipulating a deposited layer on the thinned portion to couple the photon between the coupling fiber and the microsphere.

25. The method of claim 19, wherein inducing controllable oscillations includes providing an electromagnetic field across the microsphere.

26. The method of claim 25, wherein the electromagnetic field is a microwave field with applied in an equitorial plane of the microsphere.

27. The method of claim 19, further including a method for reading the state of the photon, wherein reading the state of the photon includes coupling the photon from the microsphere into a coupling fiber and reading the state of the photon.

28. A qubit comprising;
electromagnetic energy having an intensity approximately that of a single photon, wherein the qubit basis states are the E_{φ} and Eᵣ polaizations of the TM energy mode.

29. A qubit comprising;
electromagnetic energy having an intensity approximately that of a single photon, wherein the qubit basis states are the E_{θ} polarization of the TE energy mode and the Eᵣ polaizations of the TM energy mode.
